(19) United States
(12) Patent Application Publication
(10) Pub. No.: US 2006/0229986 A1
(43) Pub. Date: Oct. 12, 2006

(54) Financial account that reduces paper check usage

(76) Inventor: Michael R. Corder, Aptos, CA (US)

Correspondence Address: Michael R. Corder, 108 Ross Rd., Aptos, CA, 95003-9757, US

(21) Appl. No.: 11/245,814

(22) Filed: Oct. 6, 2005

Related U.S. Application Data
(60) Provisional application No. 60/670,493, filed on Apr. 12, 2005.

(51) Int. Cl. G06Q 40/00

(52) U.S. Cl. 705/45

(57) ABSTRACT

A business method that will eliminate many of the paper check transactions that are currently required in today's financial environment. This method works by the creation of a deposit only financial account that is transparently linked to one (or more) normal financial account(s). Money deposited into the deposit only account immediately flows to the linked financial account(s) whose account numbers remain hidden. The method is simple to implement, is easily understood by the average user, eliminates the need for third party payment handing firms and will result in the saving of millions of dollars per day.

### CROSS-REFERENCE TO RELATED APPLICATIONS

This application claims the benefit of provisional patent application Ser. No. 60/670,493, filed Apr. 12, 2005 by present inventor.

### BACKGROUND OF THE INVENTION

1. Field of the Invention The invention relates to the general field of financial transactions and the payment of amounts owed by either paper or electronic means.

2. Prior Art

Paper checks are an enormous drain on the world's financial system. The cost of handling and moving paper checks amounts to millions of dollars every day. The financial industry has tried to reduce the number of paper checks it handles. Recently, images of checks have been accepted as stand-ins for the actual check. This has eliminated the need to physically move checks every night back to the originating financial institution. Although this eliminates some handling of physical checks, it only solves a portion of the physical check problem. There are still an enormous number of paper checks in the system. A recent Bank of America TV advertisement stated that they handle forty million checks a day.

One large use of physical checks is in the area of manufacturer's rebates. This is a popular trend today whereby the customer sends in a rebate form which creates business expenses in the physical cutting of the check, the mailing of the check and the subsequent handling of the check when cashed by the customer. Another large generator of paper checks is on-line financial transactions. When a person pays a large corporation, the bank prefers to use electronic funds transfer to pay the bill. But if the payee is a small corporation or private individual, the bank must issue a paper check with all its associated costs. Other common uses of paper checks are obvious. Thus the problem is clear—how to eliminate most of the paper checks currently in the world financial system?

Electronic funds transfer would be a much more efficient way to handle almost all situations where a check is currently issued but is resisted by the customer for a number of reasons. The major reason is that people are hesitant to give out their financial account information for fear that funds will somehow be removed from their financial account without their permission. If this fear could be completely eliminated, most people would be willing to be paid with a non-paper means.

3. Objects and Advantages

Accordingly, several objects and advantages of this business method are:
1. Eliminate many of the paper check transactions that are currently required in today's financial environment. This method works by the creation of a deposit only financial account that is transparently linked to one (or more) normal financial account(s).
2. Elimination of the need for millions of paper checks in everyday commerce with the attendant reduction of millions of dollars in expenses related to the physical handling, processing, transfer and storing of these physical documents.
3. Complete security of funds transfer from payer to payee. Enhanced security of transactions due to the electronic nature of the transactions and the hiding of the account number(s) of the ultimate depository account(s).
4. Reduction in the need for third party payment reconciliation services, such as PayPal, which require access to the payees bank account number,with the accompanying risk of account number theft, in order to deposit transferred funds.

### SUMMARY

A business method which will eliminate many of the paper check transactions that are currently required in today's financial environment via the creation of a deposit only financial account which is transparently linked to one, or more, normal financial accounts. Use of this business method will result in the saving of millions of dollars per day to the financial industry.

### DRAWINGS

FIG. 1—A comparison of deposit only and normal financial accounts showing how money can flow into or out of a normal financial account but only into the deposit only account defined in this business method.

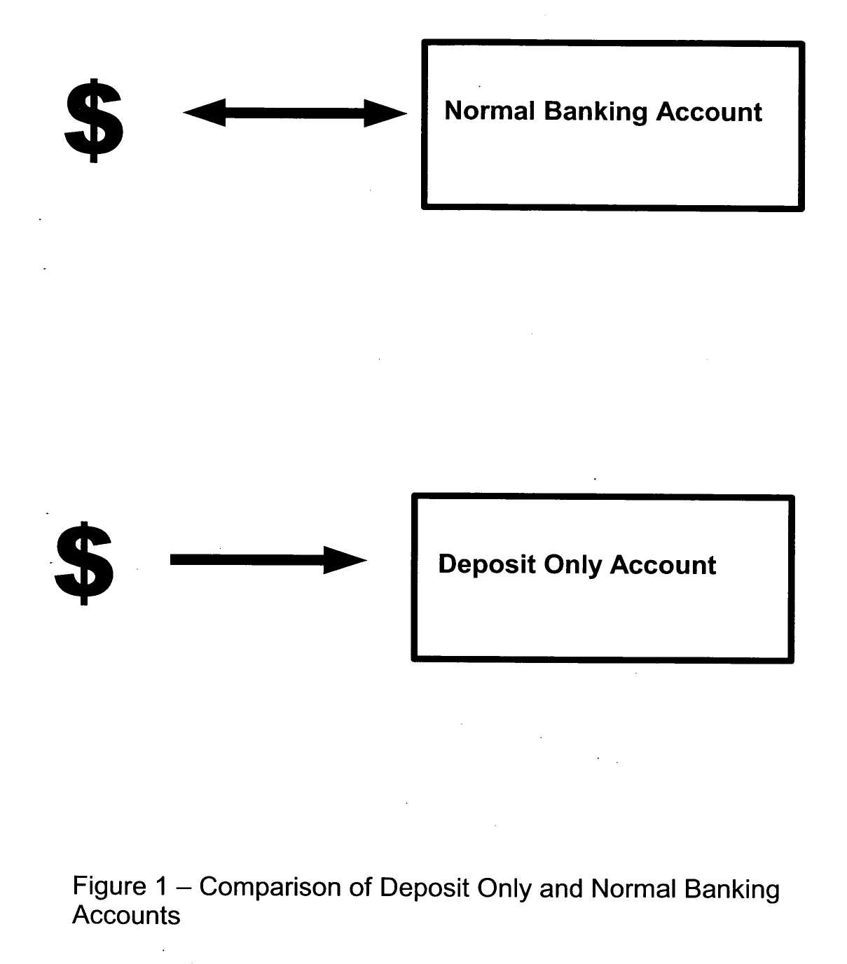

FIG. 2—How money flows from a deposit only account into one normal financial account.

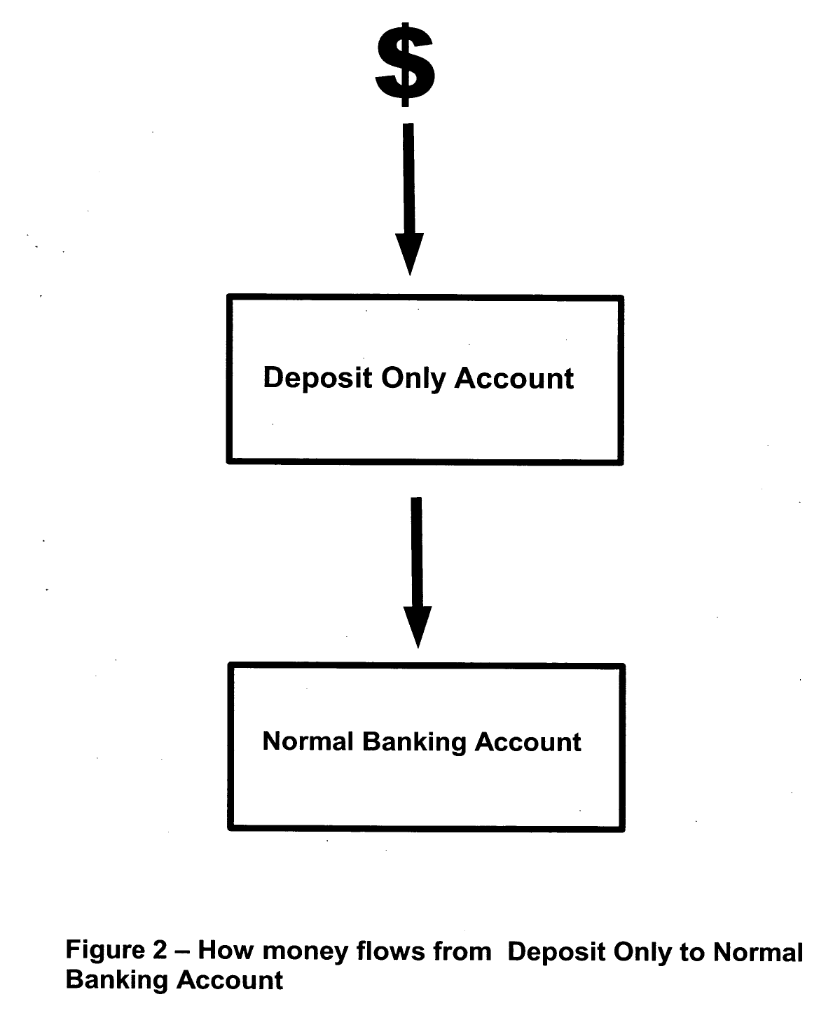

FIG. 3—How money flows from a deposit only account into more than one normal financial account according to a predefined sorting rule.

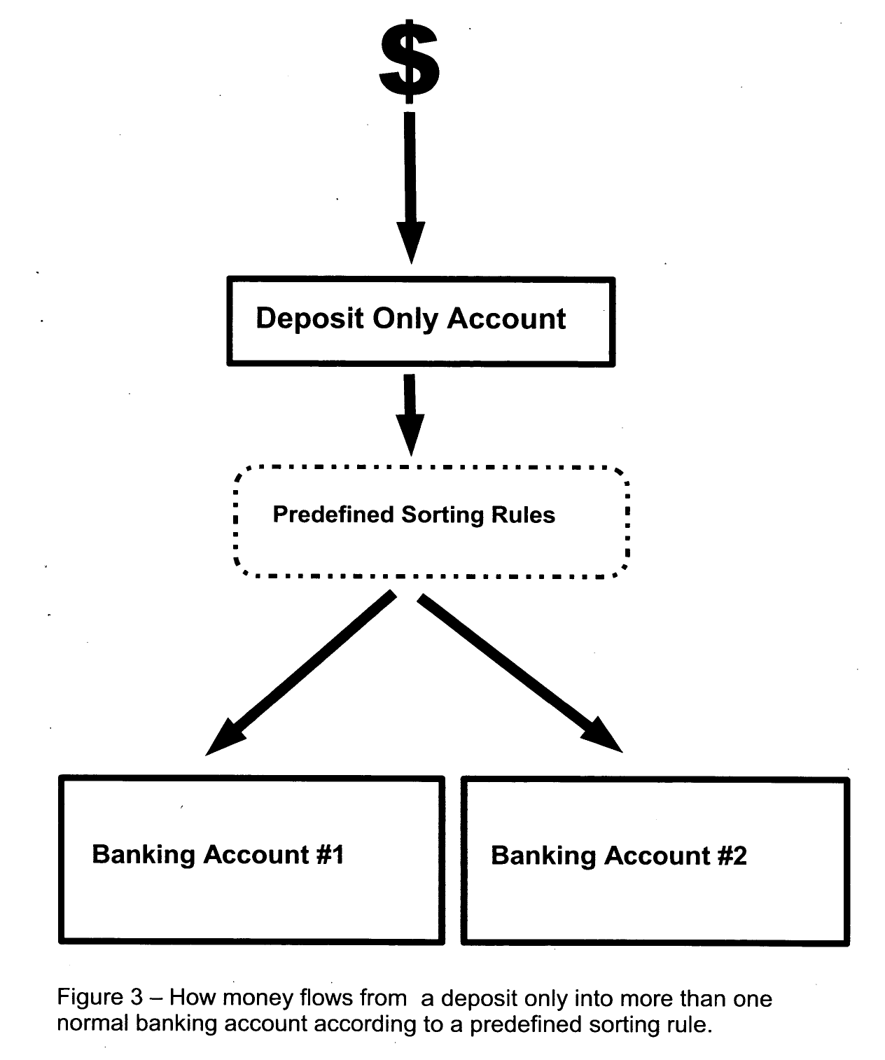

### DETAILED DESCRIPTION

This business method eliminates the need for paper checks by creating a deposit only financial account that functions only as a place to deposit funds. Money may be deposited into the account (electronically or by other means) but never withdrawn by any method. The deposit only account is linked automatically to one (or more) normal financial accounts. Money deposited into a deposit only account immediately flows into a normal financial account. The deposit only account always has a balance of zero and serves as a barrier to knowledge of the account information of the account linked to the deposit only account. Accordingly, the account number of the deposit only account may be freely given out since the knowledge of this number does not lead to any financial risk. The linkage between the deposit only account and the normal financial account is known only by the customer and the financial institution.

Several additional features are possible with the business method. If desired, the deposit only account may be linked to more than one regular financial accounts. If there is more than one linked account, the flow of money from the deposit only account to the normal financial accounts may be made by any prearranged sorting algorithm. For example, funds might flow to different accounts according to a fixed percentage of the total deposited; such as 40% to Account A and 60% to Account B. Another sorting algorithm might be based on the monetary value of the check with amounts less than $50 going into Account A and amounts greater than this going into Account B. Other sorting methods are possible and easily envisaged.

An additional feature of the method is the optional ability to notify the customer when the money has been deposited to the deposit only account. If desired, the deposit only account can be set up such that the financial institution automatically notifies the customer by electronic mail, cellular text messaging, cellular voice messaging, instant messaging, mail or other convenient means, that the amount has been deposited into their deposit only account showing payee, monetary amount, account dispersal details and other such information as might be of interest. Obviously, this information could be encrypted if so desired.

Another advantage of this method is that it provides a more secure method of payments than existing third party services such as PayPal. With such third party payment processors, it is necessary to disclose your bank account number to the third party even for just deposit type uses. This method eliminates that need and its attendant lack of security.

### CONCLUSIONS, RAMIFICATIONS AND SCOPE

In summary, this business method solves a problem costing world businesses millions of dollars a day. It is simple to implement and easy to understand. The concept of a public bank account number which may be freely given to others since it is tied to a financial account which, by definition, never has any money in it, is innovative yet comprehensible by anyone.

The business method should prove acceptable to most users who would currently resist any form of electronic financial transaction and insist on being paid by paper check. It may, very possibly, lead to more financial transactions of smaller amounts than are currently used since the cost of a small transaction is much less than if it were transacted with a paper check.

The method is extensible. Money that flows into the deposit only account may be sorted by a number of predefined methods such as a fixed percentage to each account, sorting based on the amount of the deposit, sorting based on the amount of money in the primary deposit account, etc. The flexibility of these sorting rules and the security of the method should keep the marketing departments of financial institutions busy for years as they differentiate their deposit only offerings from their competitors.

The method provides for an optional means of notification when money has been deposited. There are many times when such notification would be useful. Notification could be made via automated phone call, email, instant messaging (either web or telephone based), or any number of similar methods. If desired, the notification could be encrypted by an acceptable means to insure security.

The method also eliminates the need for third party payment services such as PayPal. These services provide two basic functions depending whether a person is the buyer or seller:

1. Collection of amounts owed

2. Payments of amounts owed

It is inherent in the method that it covers both points. The payer can use their normal banking electronic bill payment service to transfer money to the payees deposit only account. The time delay in such a payment could be as short as the financial institution is willing to support. As noted, the method allows for immediate notification that the money has been received. Use of the method in this manner eliminates the need for the payment of the normal fees collected by these third party organizations and reduces the cost of remote transactions.

As may be seen, in summary the method is easy to implement, easy to understand and will result in the savings of enormous sums of money in a very short time.

What is claimed is:

1. A method of eliminating the need for paper checks comprising:

2. The creation of a deposit only financial account that is linked to a regular financial account in a manner known only to the account holder and the financial institution. Said deposit only account is identified by an account number which can be freely given out to third parties since said deposit only account never contains any funds but merely serves as a depository for funds which immediately flow into said regular financial account.

3. Proceeds of a deposit into said deposit only account may optionally be dispersed into more than one said regular financial accounts according to predefined sorting rules. Examples of possible sorting rules are:

4. A fixed percentage of said proceeds going into the first said regular financial account and the remainder of said proceeds going into another said regular financial account. This rule could be applied in a recursive manner if desired.

5. Said proceeds could be dispersed according to a sorting rule whereby the entire amount of said proceeds would flow into one of two or more said regular financial accounts based on the total amount of said proceeds.

6. Optional notification of the said account holder of the receipt of said proceeds by means of phone, email, regular mail, instant messaging, text messaging or other such means.

7. Said notification may be encrypted if desired.
